(19) United States
(12) Patent Application Publication
(10) Pub. No.: US 2011/0232041 A1
(43) Pub. Date: Sep. 29, 2011

(54) Portable Apparatus for Securing Objects to a Surface or a Person

(75) Inventor: Sarah Mott, Cheshire, CT (US)

(73) Assignee: SARAH BRENNAN MOTT, Cheshire, CT (US)

(21) Appl. No.: 12/732,933

(22) Filed: Mar. 26, 2010

(51) Int. Cl. F16B 2/24; F16B 2/20

(52) U.S. Cl. 24/3.12; 24/568

(57) ABSTRACT

The apparatus comprises a gripper for securely holding an object and a holder for attaching to a surface. The holder is secured to the gripper and is operable to be attached to the surface at a location away from area where the gripper is secured to the holder. The gripper is capable of movement so as to engage and disengage with the object. The holder is capable of movement so as to engage and disengage from the surface. The holder and the gripper engage and disengage with the surface and the object respectively by moving in directionally different planes to ensure a secure grip during engagement.

### FIELD OF THE INVENTION

The present invention relates to a portable apparatus for securing objects to a surface or person, and more particularly, to a method and an apparatus for securing a stethoscope to a surface or a person.

### BACKGROUND OF THE INVENTION

Pocket clips or belt clips are usually used as hand-free portable devices to hold objects for easy access. Pocket clips have a side arm on an object so that the object can be clipped onto a pocket. Pocket clips have limited applications due to the requirement of having a side arm. Belt clips typically have a clip component for attaching the device to a belt, and a hook or pocket component for receiving objects, such as key, a cellular phone, or a portable printer. But belt clips can only hold certain types of objects due to the dimensional limitations of the hook and the pocket. Moreover, both pocket clips and belt clips rely on the clip function to attach to belts or pockets which are not very secure. The clips may flip out from the pocket or belt of a person when the person moves around.

In the medical industry, the ability of easily accessing devices provides an on-going challenge. It is crucial to provide portability in such environments because accessing equipment easily while working simultaneously on patients is a requirement. To exacerbate the problem, medical devices may be difficult to hold or carry. For example, a stethoscope which does not have a small and fixed shape is difficult to manipulate. A stethoscope is an important medical instrument carried upon by most caregivers for instantly retrieval. Generally, a stethoscope is stuck in the pockets of garments until the stethoscope is used. But some garments may not have a pocket of sufficient size for a stethoscope. Alternatively a stethoscope is placed around a caregiver's neck for easy access. This, however, often causes irritating rubbing between the ear pieces of stethoscope and the neck, and may even lead to neck injury if the caregiver carries the stethoscope on the neck for extended period of time.

Clip-on devices have been invented for attaching the stethoscope to a belt. Unfortunately, these devices either cannot retain the ear pieces, the tubes and the chest pieces of the stethoscope in a fixed position, or requires a lot of time and effort to put each piece of the stethoscope in the pre-defined positions. Moreover, the devices tend to fall off from the belts to a floor which causes contamination and even damage to stethoscopes.

Thus, a need exists for an improved portable apparatus that can readily hold an article with different dimensions and shapes, such as a stethoscope, and at the same time securely attach to a pocket, belt, or other object.

### SUMMARY OF THE INVENTION

The shortcomings of the prior art are overcome and additional advantages are provided through the provision of a method and an apparatus that allows objects to be secured to a surface or a person.

The apparatus comprises a gripper for securely holding an object and a holder for attaching to a surface. The holder is secured to the gripper and is operable to be attached to the surface at a location away from area where the gripper is secured to the holder. The gripper is capable of movement so as to engage and disengage with the object. The holder is capable of movement so as to engage and disengage from the surface. The holder and the gripper engage and disengage with the surface and the object respectively by moving in directionally different planes to ensure a secure grip during engagement.

In one embodiment, the apparatus comprises a holder and a gripper which is connected substantially to one end of the holder. The holder opens and closes in a substantially vertical manner to allow the holder to attach to a surface when in an open position and securely remain attached to the surface when in a close position. The gripper opens and closes in a substantially horizontal manner to allow storing of an object such that the object and the surface become securely attached to one another via the holder and the gripper combination. The apparatus is also suitable for securing a stethoscope to a surface or a person.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is a cross sectional illustration of the portable securing apparatus according to one embodiment of the present invention;

FIG. 2 is a cross sectional illustration of the portable securing apparatus of FIG. 1, rotated at an angle and secured to a surface while holding an object;

FIG. 3 is a cross sectional, side view illustration of the portable securing apparatus according to an alternate embodiment of the present invention;

FIG. 4 is side view illustration of an alternate embodiment of the present invention; and

FIG. 5 is top down view illustration of the embodiment of FIG. 4 providing an 180 degree perspective.

### DETAILED DESCRIPTION

In accordance with embodiments of the invention described herein, an apparatus is provided by which an object can be securely attached to a surface or a person.

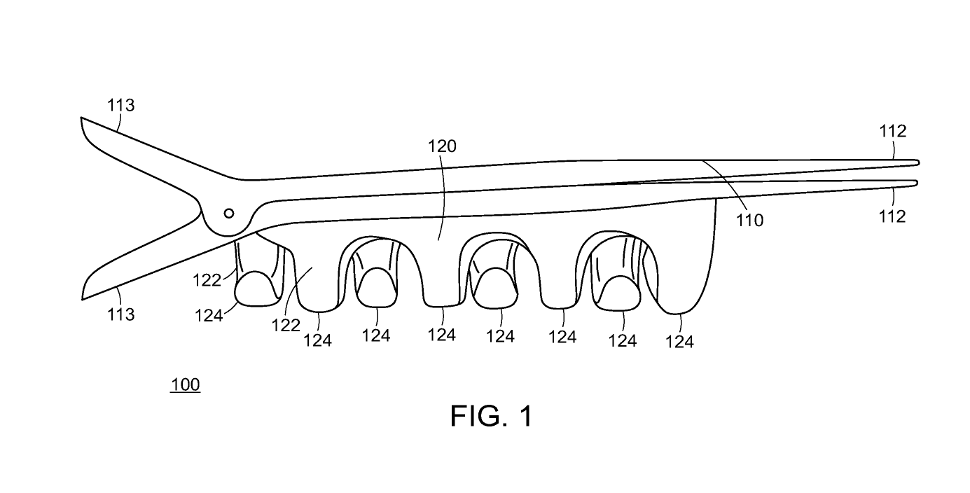

FIG. 1 is a sectional, side view illustration of an apparatus according to one embodiment of the present invention. The apparatus is referred in FIG. 1 by numerals 100. The apparatus comprises a holder 110 and a gripper 120 which is secured at a location selectively to the holder 110. The gripper 120 is enabled to securely hold an object and the holder is enabled to securely attach to a surface or another object such as a person's clothing. As will be discussed in more detail, the gripper and the holder are both enabled and capable of movement so as to open and close and engage and disengage with the surface and/or object. The gripper is secured to the holder along its edge as shown or at one or more locations. In one embodiment, the holder is operable to be attached to the surface at a location away from area where said gripper is secured to the holder. In this embodiment, the holder and the gripper engage and disengage with the object and surface by moving in directionally different planes to ensure a secure grip during engagement to both the surface and for the object. In one embodiment, the gripper and holder are secured to one another at an angle, preferably in a substantially perpendicular manner such that when one is positioned in a substantially vertical direction, the other is disposed in a substantially horizontal direction. However, in alternate embodiments, this arrangement can be selectively varied.

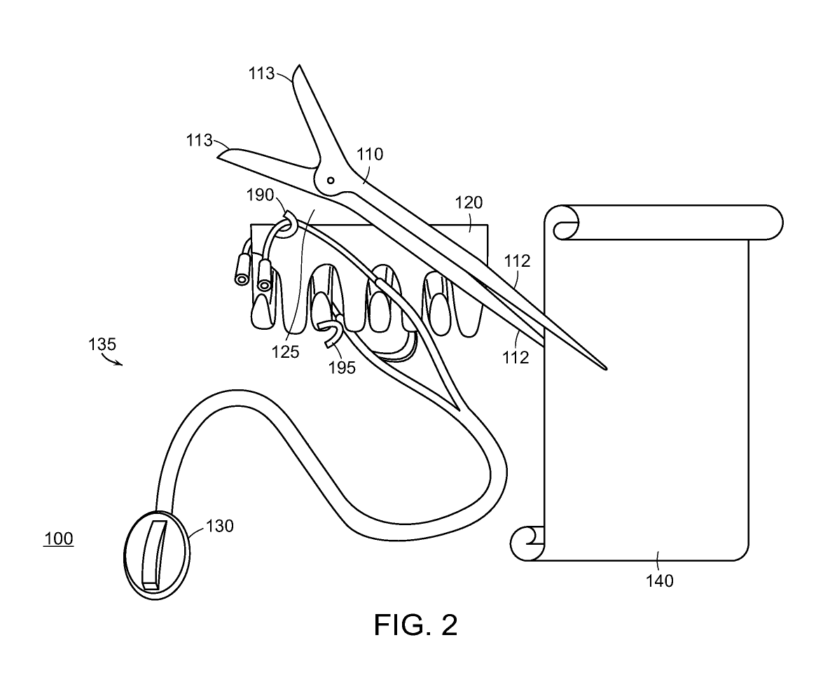

FIG. 2 is side view illustration of the apparatus 100 of FIG. 1, rotated at an angle and holding such an object. As can be viewed in FIG. 2, the gripper 120 securely holds an object (i.e. a stethoscope) 130 and the holder 110 is attached to a surface 140 (i.e. a clip board). Consequently, the object 130 is securely attached to the surface 140 by the holder 110 and the gripper 120 combination.

In one embodiment, the gripper 120 and the holder 110 directionally function in different planes such as to maximize the securing of the object to the surface. In this embodiment, the gripper 120 and the holder 110 can be disposed such that they are substantially perpendicular to one another, or alternatively disposed at a different angle to one another. For example, as shown in FIGS. 1 and 2, the gripper 120 can be disposed to move from a first to a second position, such as an open and close position, in a substantially horizontal direction along the x-axis. At the same time, the holder 110 can also move from a first to a second direction, such as open and close position, in a substantially vertical direction along the y-axis. However, the above example is only used for ease of understanding and a variety of other directionally oriented embodiments can be provided for the gripper and holder to be oriented in as suggested earlier and can be appreciated by those skilled in the art.

The gripper 120 and the holder 110 can comprised of a variety of different designs as can be appreciated by those skilled in the art. In one embodiment, for example, the holder 110 can resemble an alligator clip. FIGS. 1 and 2 show such an example. In one embodiment, as shown by these figures, the holder clip can comprises a plurality of members that can be disposed such that when in closed position, holds the surface or the object securely. In the examples shown in the figures, the holder 110 has two members 112. Each member includes handles 113 and arm sections 114 connected to one another. In these examples, the two members 112 are connected to one another by a spring or spring like component (not visible) disposed between the two handles 113 or similar structure such that when the handles are pushed toward one another, the arm sections 114 are moved away from one another to allow the holder to open. The members (i.e. arm sections 114) are then disposed around the desired surface/object 140. Once the handles are released, the arm sections return to their original position, adjacent to one another, allowing the holder to close and securely attach to the desired surface and/or object 140.

The surface or object 140 can comprise a variety of objects and/or surfaces including but not limited to clip boards, posters, portable carts, walls, tables, and/or a person's clothing or an article worn by a person, such as a belt or a pocket or such similar surfaces as known to those skilled in the art.

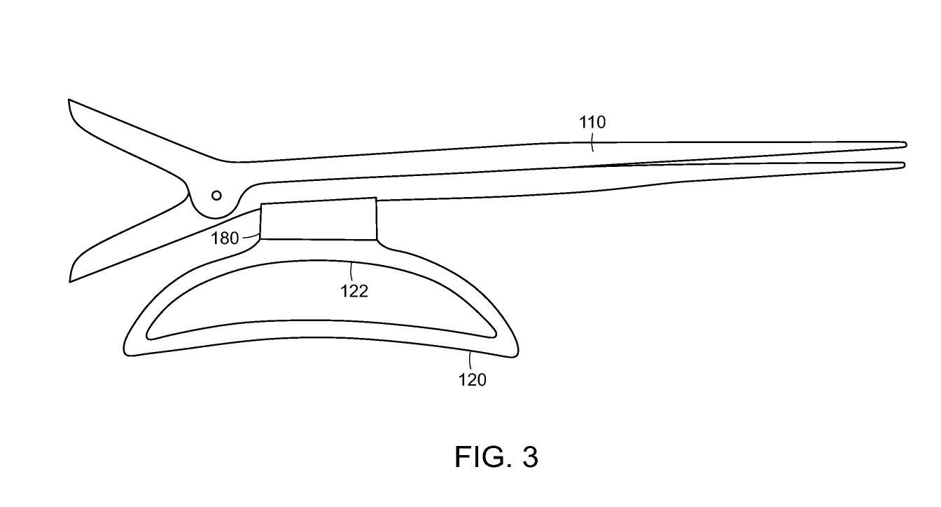

As discussed, the gripper 120 can also comprise many designs. In FIG. 3, as per one example, the gripper 120 is shown to resemble a clam clip. In such an example, the clip comprises at least two components 122 that are complementary to one another such that they open and close to hold an object. In the illustration of FIG. 3, only the top component 122 is visible but the bottom component (not visible) is disposed under the top component 122. The gripper 120 in this embodiment is attached to the holder 110 at a single point shown at 180.

In alternate embodiments, other designs can be used instead of a clam clip. Such examples were shown in embodiments of FIGS. 1 and 2. In FIGS. 1 and 2, the gripper 120 comprised a plurality of components 122 having complementary interlocking extensions 124. In the embodiments shown a plurality of interlocking extensions 124 are shown (i.e. 4 in FIGS. 1 and 2). Although less than three interlocking extensions 124 per component may be used in alternate embodiments, better results are achieved when more than three extensions 124 are used. In the example provided, the extensions 124 are shown to be similar to teeth/fingers in structures but alternate designs can be used.

The extensions 124 can be placed at regular spaced intervals from one another or selectively distanced. The extensions 124 can be of the same or of various shapes and widths and even fabricated of different materials.

In one embodiment, the extensions 124 can selectively be shaped to provide a protective contour such as to minimize damage to surrounding areas or objects that they hold. Such protective contours can be provided in a variety of manners as can be appreciated by those skilled in the art. In one example, as shown in FIGS. 1 and 2, the contoured shape includes rounded edges in order to protect the object from being damaged during the opening and closing of the extensions 124. In yet another embodiment, additional protective measures can be added to further protect the object 130 from being damaged. For example, in one example, the extensions 124 can be further accessorized with protective coating or even alternatively with protective sleeves to minimize such damage.

In one embodiment, the components 120 can be secured to one another via a fastener like structure 125 (in FIG. 2) that can have selectively spring like components or movement for maximum security of closing.

In one embodiment, the gripper 120 and the holder 110 are made as a unitary apparatus. But they can be connected to one another by a fastening component or adhesives. They can also be fused together. In addition, the gripper 120 and the holder 110 can be made out of a variety of materials including but not limited to high strength plastics, surgical steel, or a combination of plastic and steel.

Referring back to FIG. 2, in a preferred embodiment, the apparatus 100 is used to hold medical devices, and particularly stethoscopes as shown. In such instance, it is desirable for the apparatus 100 to be fabricated of surgical steel to maximize sanitation. Furthermore, additional stethoscope protectors can be provided in a variety of shapes to hold the hanging end of the stethoscope 135. In this example, hooks 190 and 195 are provided in two alternate areas. One or a plurality of such hooks (or other stethoscope protectors) can be provided in a variety of locations on the apparatus. For example, in the figure an integrated hook 195 is provides as part of the extensions 124 and alternatively hook 190 is provides as part of the holder 110. The hooks can be detachable or integrated selectively. Consequently, when used in conjunction with the apparatus 100, the stethoscope of this example, when no longer in need, can be neatly wound up (a person can wind the tubes, the ear pieces and the chest piece of the stethoscope and even attach it to the hooks 190/195) and attached the apparatus to a pocket or other surface until the device is needed again.

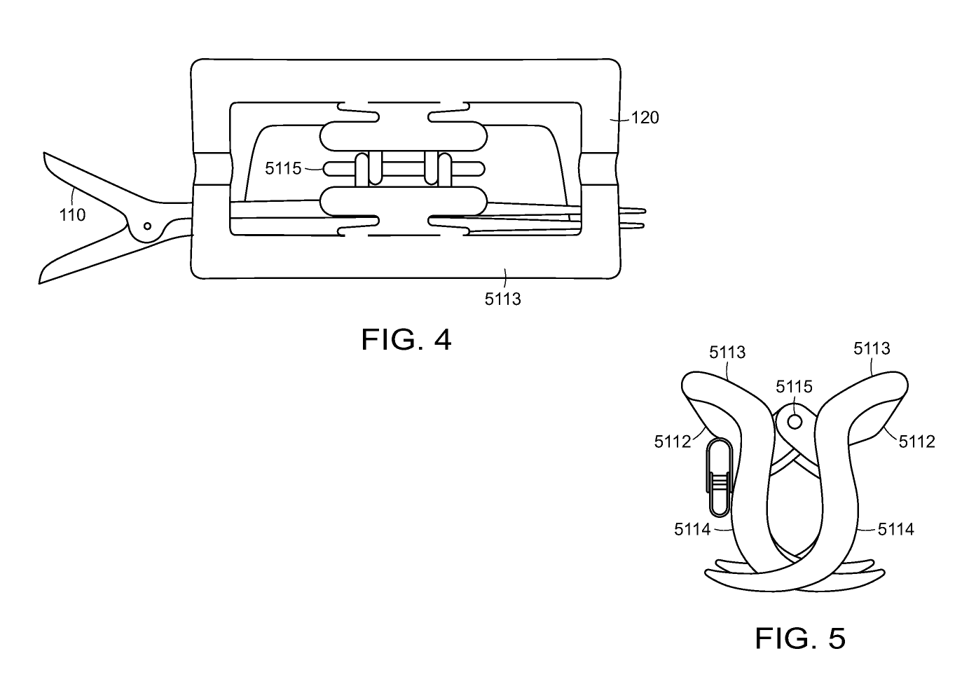

FIG. 4 is an illustration of an alternate embodiment of the present invention. FIG. 5 is another illustration of the alternate embodiment of FIG. 4, but rotated at a 180 degree angle to make some of the features more visible. Consequently, a discussion of FIGS. 4 and 5 will be provided together for ease of understanding. In FIG. 4, the holder 110 is still similar to the one discussed in conjunction with prior embodiments. However, the gripper 120 now comprises of a different design. The holder is comprised of a holding component 5113 which secures the object 130 as previously discussed. The component can be a unitary single component or as shown in the example provided in the figure can be further comprised of additional components. In the embodiment shown, the component 5113 comprises two complementary interlocking parts 5114 that move toward and away from one another from a first to a second position of open and close to enable holding of the object 130. The interlocking elements 5114, are shaped with a curved structure as shown such as to minimize damage and maximize their holding ability as with regards to the objects previously discussed (130).

The holder 120 also comprises a central component 5112 that in one embodiment further connects the two complementary interlocking parts 5114. The central component also enables the moving of the two interlocking components from open to closed positions using a variety of means as known to those skilled in the art. In the embodiment shown, this is enabled by means of a spring 5115. The central component 5112 can be of a unitary, single construct or be also comprised of a plurality of components.

While the invention has been described in accordance with certain preferred embodiments thereof, those skilled in the art will understand the many modifications and enhancements which can be made thereto without departing from the true scope and spirit of the invention, which is limited only by the claims appended below.

What is claimed is:

1. An apparatus for securing an object to a surface, comprising:
a gripper for securely holding said object, said gripper capable of movement so as to engage and disengage with said object; said gripper being secured to a holder;
said holder operable to be attached to said surface at a location away from area where said gripper is secured to said holder; said holder capable of movement so as to engage and disengage from said surface;
said holder and said gripper engaging and disengaging with said surface and said object respectively by moving in directionally different planes to ensure a secure grip during engagement.

2. The apparatus of claim 1, wherein said holder and gripper open and close to engage and disengage with said surface and object.

3. The apparatus of claim 1, wherein said holder and said gripper are substantially perpendicular to one another such that when one is positioned in a substantially vertical direction, the other is disposed in a substantially horizontal direction.

4. The apparatus of claim 1, wherein said apparatus further comprises a hook for securely storing any hanging ends of said object not gripped by said gripper.

5. The apparatus of claim 1, wherein said gripper and said holder are disposed on angled planes intersected by one another.

6. An apparatus for securing an object to a surface, comprising:
a gripper for securely holding said object;
said gripper being secured to a holder at substantially a one end;
said holder operable to be attached to said surface substantially at an opposing end;
said holder opening and closing in a substantially horizontal manner to allow said holder to attach to said surface when in an open position and securely remain attached to said surface when in a close position; and
said gripper opening and closing in a substantially vertical manner to allow storing of said object such that said object and said surface become securely attached to one another via said holder and said gripper combination.

7. The apparatus of claim 6, wherein said object is a stethoscope.

8. The apparatus of claim 7, wherein said surface is a person's clothing.

9. The apparatus of claim 8, wherein said surface is a belt.

10. The apparatus of claim 6, wherein said gripper is further comprised of a plurality of components connected to one another by a fastener.

11. The apparatus of claim 10, wherein said gripper has two components, each component having complementary interlocking extensions.

12. The apparatus of claim 11, wherein said each component has at least three interlocking extensions.

13. The apparatus of claim 12, wherein said interlocking extensions have round edges to protect said object from being damaged.

14. The apparatus claim 12, wherein said round edges further have protective coating.

15. The apparatus of claim 12, wherein said round edges have protective sleeves.

16. The apparatus of claim 6, wherein said holder and said gripper are fabricated as an integral unit.

17. The apparatus of claim 6, wherein said holder and said gripper are connected to one another by a fastening component.

18. The apparatus of claim 6, wherein said gripper and said holder each have a component to allow them to close using a spring like movement to ensure a secure grip.

19. The apparatus of claim 6, wherein said apparatus is fabricated from surgical steel.

20. A method for securing an object to a surface, comprising:
securing an object to a gripper; said gripper capable of movement so as to engage and disengage with said object;
attaching said gripper to a holder; said holder operable to be attached to said surface at a location away from area where said gripper is secured to said holder and said holder also capable of movement so as to engage and disengage from said surface;
engaging and disengaging said holder and said gripper with said surface and said object respectively by moving them in directionally different planes to ensure a secure grip during engagement.
